(19) United States
(12) Patent Application Publication
(10) Pub. No.: US 2004/0170319 A1
(43) Pub. Date: Sep. 2, 2004

(54) System and method of gamut mapping image data

(76) Inventor: Ron P. Maurer, Haifa (IL)

Correspondence Address: HEWLETT-PACKARD COMPANY, Intellectual Property Administration, P.O. Box 272400, Fort Collins, CO, 80527-2400, US

(21) Appl. No.: 10/377,911

(22) Filed: Feb. 28, 2003

(51) Int. Cl. G06T 5/00

(52) U.S. Cl. 382/167; 382/254

(57) ABSTRACT

A system and method of gamut mapping/clipping is described. The system and method applies to original image data color values in an original color space that have been transformed to obtain an original luminance value having an associated luminance/chrominance based color space and original chrominance values. The original luminance value is processed to obtain a processed color value having a processed luminance value and the original chrominance values. According to the system and method, the processed color value is mapped back into the original color gamut by selecting a target color value on a luminance axis. A different target color value is selectable for each of a plurality of color values of the image data. A mapped color value is then determined by linearly projecting from the processed color value towards the target color value. The mapped color value is located at the intersection of the gamut boundary of the original color space and the projection.

### FIELD OF THE INVENTION

The present invention relates to systems and methods of gamut mapping image data.

### BACKGROUND OF THE INVENTION

Color images captured by devices such as scanners, digital cameras, etc. are often represented by RGB (red, green, blue) color values associated with a RGB color space. Each color value is made up of three component values, one for each of the red, green, and blue colors. The range of each color component value is between 0 and some maximum M (usually M=255).

Images are often processed to enhance their appearance. In one type of image enhancement technique, enhancement is applied only to the luminance component of a image and not the chrominance component of image data. FIG. 1A shows one technique for luminance channel only enhancement on RGB image data. Initially, the RGB values are transformed into luminance and chrominance values (Y,C₁,C₂) in a YCC luminance-chrominance color space. It is well known in the field of color theory that a category of color spaces (sometime referred to as YCC) is generally defined by having a luminance channel and two chrominance channels. This category can include but is not limited to YIQ, YUV, YC_{b}Cᵣ, etc. After converting to a Y,C₁,C₂ color value, only the luminance component (Y) values are enhanced/processed (i.e., a tone mapping for contrast enhancement, or a sharpening) resulting in a processed color value, Y′,C₁,C₂. Then, the processed value is transformed back into the RGB color space for displaying on a monitor or some other RGB output device. One of the main disadvantages of this type of image data processing is that the transformations between color spaces can be computationally costly.

In one known technique (shown in FIG. 1B) specifically based on applying enhancement to the luminance component in the YIQ color space, forward chrominance channel transformations and all backward color channel transformations between RGB and YIQ color spaces is avoided by applying the luminance enhancement/adjustment directly in the RGB color space (while still retaining both hue and chroma) thereby avoiding most of the costly color space transformations. According to this technique, the luminance component values are determined from the RGB image data and a luminance shift value ΔY corresponding to a shift from the original luminance value Y to an adjusted luminance value Y′. The shift value is used to determine adjusted/processed color values, R′, G′, B′ according to Eq. 1 below:

$$[ \begin{matrix}{R}^{′} \\ {G}^{′} \\ {B}^{′}\end{matrix} ] = [ \begin{matrix}R + Δ Y \\ G + Δ Y \\ B + Δ Y\end{matrix} ] \qquad ( 1 )$$

It should be noted that Eq. 1 provides a manner in which to perform luminance-only modification which by-passes most of the color space transformations. This technique is based on a unique transformation between YIQ and RGB as defined the forward and backward transformation matrixes below in Eq. 2 and 3:

$$\begin{matrix}[ \begin{matrix}Y \\ I \\ Q\end{matrix} ] = T [ \begin{matrix}R \\ G \\ B\end{matrix} ] where T = [ \begin{matrix}0.299 & 0 .587 & 0 .114 \\ 0.596 & - 0 .274 & - 0 .322 \\ 0.211 & - 0 .523 & 0 .312\end{matrix} ] & ( 2 ) \\ [ \begin{matrix}R \\ G \\ B\end{matrix} ] = {T}^{- 1} [ \begin{matrix}Y \\ I \\ Q\end{matrix} ] where {T}^{- 1} = [ \begin{matrix}1 & 0 .956 & 0 .621 \\ 1 & - 0 .273 & - 0 .647 \\ 1 & - 1 .104 & 1 .701\end{matrix} ] & ( 3 )\end{matrix}$$

The problem with the above luminance processing methods is that the adjusted R′G′B′ values may lie outside the original image RGB-gamut, namely outside the range [0,M] for at least one of the R,G,B component values. In order to make it possible for the RGB output device to display the processed image data, the values are typically mapped back into the original RGB color space. In particular, the processed RGB color values are mapped to a point back within the RGB color space. In general, in order to preserve visual quality, it is undesirable to map one color component of a given color value without appropriate mapping of the other two components of the color value in order to preserve at least one of luminance, saturation or hue. A more specific type of mapping, also referred to as gamut clipping, is performed by mapping the processed RGB color values to a point on the surface of the RGB boundary defining the gamut.

Known clipping methods are directed to preserving at least the hue, since hue shifts have been determined to be visibly objectionable. Three such methods (illustrated in FIG. 2A) are luminance-clipping, chroma-clipping, and node-clipping. FIG. 2A shows an original RGB color point (a) having an associated color value (R,G,B) within an RGB gamut. It should be noted that FIG. 2A shows a single slice corresponding to a given hue plane of a three-dimensional YC₁C₂ coordinate space. It should be further noted that the hue angle and chroma intensity are defined in terms of the two chrominance components as follows (as shown in FIG. 2B):

$$C = \sqrt{{C}_{1}^{2} + {C}_{2}^{2}} \\ h = {tan}^{- 1} ( \frac{{C}_{2}}{{C}_{1}} ) \qquad ( 2 )$$

Any color value in an RGB color space has a corresponding luminance component value (Y) and chroma intensity component value (C ) (Note: the hue angle is not shown in FIG. 2A).

After applying some processing such as contrast enhancement to the Y component only, a processed luminance component value Y′ is obtained. The hue and chroma intensity are unmodified by the luminance operation. As shown in FIG. 2A, the processed color value (i.e., point (b)=(Y′,C)) lies outside the RGB color space. Before converting back to the RGB color space, the out-of-gamut point (b) can be mapped to a point on the boundary of the RGB gamut.

The first known technique for mapping the point to the RGB gamut boundary is “luminance clipping” where point (b) is mapped to the gamut boundary at point (c)=(Y″,C) preserving chroma intensity while reducing luminance shifting from Y′ to Y″. The second known technique is “straight chroma-clipping” where point (b) is mapped/clipped to the gamut boundary at point (d)=(Y′,C′) preserving the modified luminance by reducing chroma intensity only. The third known technique is “node-clipping”, where the clipped point (e) is on a projected line connecting the point (b) with a node point on the Y-axis (Y₀,O) as shown in FIG. 2A. The particular case of node clipping with Y₀=0 is also known as “saturation-clipping”. In this case the ratio of the luminance and chrominance components associated with the clipped point will be the same as the ratio of the luminance and chrominance components associated with the pre-clipped point. This ratio defines the saturation, so that both hue and saturation are preserved. According to this prior art method, the node Y₀ corresponds to a stationary coordinate on the luminance (Y) axis to which all image data color values residing within the particular hue plane are mapped to. As described above, this value is often set to zero for all color values in all of the hue planes.

In a known psychophysical experiment comparing several gamut mapping methods when transforming back from CIE-Lab to RGB, it was shown that over-all (i.e. for the majority of the tested images), the preferred clipping method is “straight chroma-clipping” corresponding to point (d) in FIG. 2A. The results from these experiments can be applied to the YCC color spaces due to the one-to-one correspondence between the L channel in CIE-Lab and the Y channel in YCC. Nevertheless, “luminance clipping” and “saturation-clipping” are often employed, due to their smaller computational complexity compared to “straight chroma clipping”. Specifically, gamut-clipping using “luminance clipping” and “saturation-clipping” is obtained without any need for forward chrominance transformations and all backward color channel transformations. Whereas, current known methods for performing a perceptually preferable “straight chroma clipping” algorithm are considerably more complex.

Hence a need exists for a more efficient system and method requiring minimized color value computation and processing for performing “straight chroma clipping”, and other related clipping methods referred to as “node-clipping”.

### SUMMARY OF THE INVENTION

A system and method of mapping previously processed color values into an original gamut is described. The system and method applies to processing original image data color values in an original color space that have been transformed to obtain an original luminance value having an associated luminance/chrominance based color space and original chrominance values. The original luminance value is processed to obtain a processed color value having a processed luminance value and the original chrominance values. According to the system and method, the processed color value is mapped into the original color space by selecting a target color value on a luminance axis. A different target color value is selectable for each of a plurality of color values of the image data. A mapped color value is then determined by linearly projecting from the processed color value towards the target color value. The mapped color value is located at the intersection of the boundary of the original color space and the projection. Wherein a gamut mapping technique is performed in which forward and backward chrominance channel transformation is obviated according to the system and method of the present.

### BRIEF DESCRIPTION OF THE DRAWINGS

FIG. 1A shows a prior art technique of applying enhancement to the luminance component of an RGB color images;

FIG. 1B shows another prior art technique of applying enhancement to the luminance component of an RGB color images without transformation;

FIG. 2A illustrates prior art techniques of gamut mapping within a hue plane of an RGB color space;

FIG. 2B illustrates the relationship between hue angle and chroma intensity and the corresponding chrominance component values (C₁,C₂);

FIG. 3A shows an image processing system that illustrates applying enhancement to the luminance component of an RGB color images without transformation and applying a first embodiment of gamut mapping in accordance with the present invention; and

FIG. 3B shows the graphical representation of the variable node gamut mapping process performed according to the system shown in FIG. 3A.

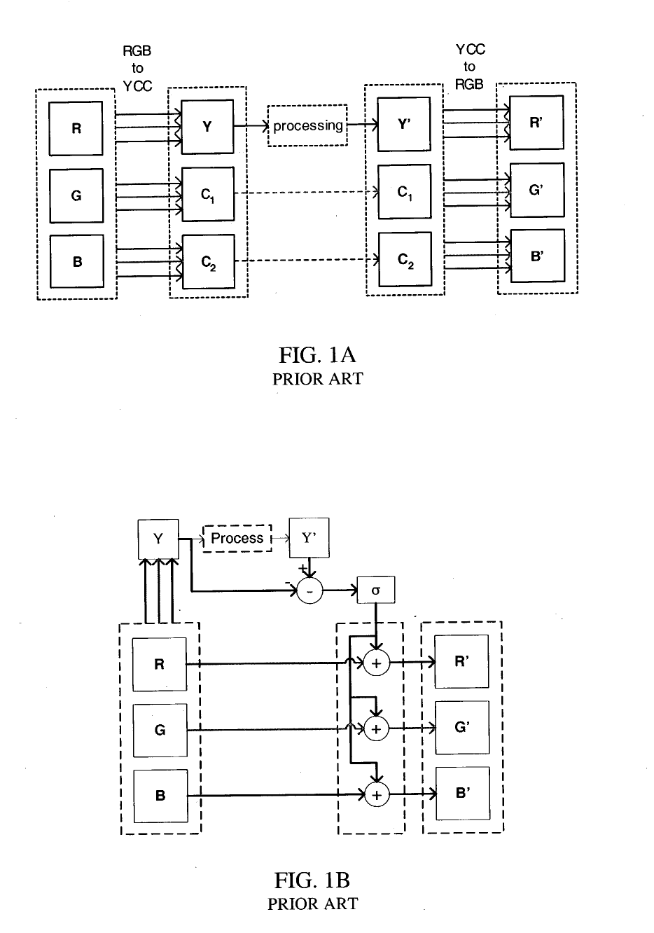

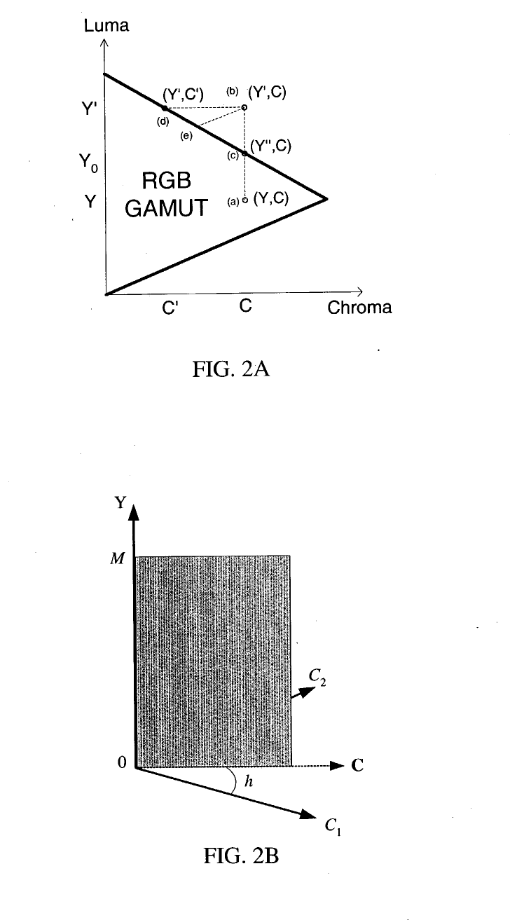

### DETAILED DESCRIPTION OF THE INVENTION

The present invention is a system and method of “variable node” clipping/mapping that applies to any YC₁C₂ color space including but not limited to YUV, YIQ, YCbCr without the need for forward and backward chrominance channel color space transformation. According to the present application “variable node” clipping/mapping can be generally defined as a mapping technique for mapping out-of-gamut processed color values (having only the luminance channel processed while maintaining the chrominance channel values) back in-gamut by using a target node that can be varied for each pixel in a given image. The technique allows for the variable clipping of different pixels or groups of pixels corresponding to different areas (e.g. bright sky, background) within an image based on a selected target value for optimized clipping. It should be noted that although the system and method of the present invention is described in terms of a “clipping” method in which out-of-gamut values are mapped to the boundary defining the in-gamut values, the system and method of the present invention also applies to mapping out-of-gamut values back into (i.e., not just onto the boundary) the desired/target gamut using a variable target node as will be described herein.

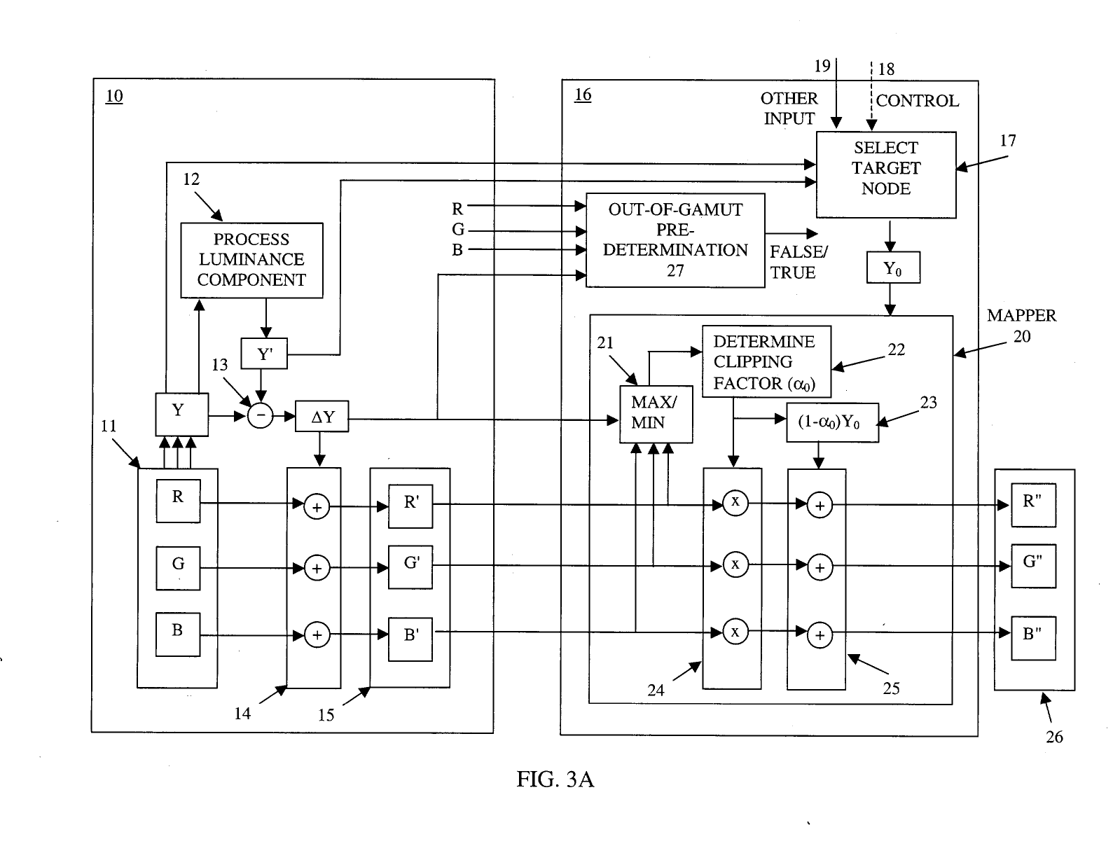

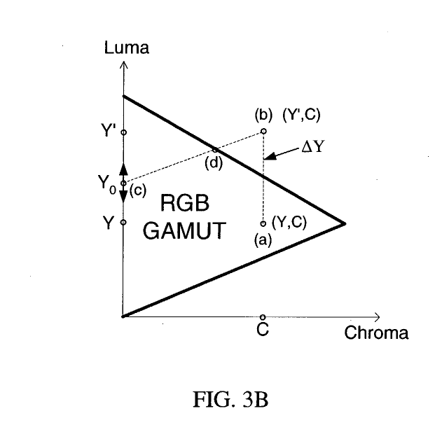

FIG. 3A shows an image processing system that illustrates, in part, the mapping technique of the present invention. In particular, FIG. 3A shows a first processing block 10 applying enhancement to the luminance component of an RGB color image without chrominance channel transformation to obtain an processed color image. In particular, a forward transformation of an original RGB color value 11 is performed to obtain a corresponding luminance value Y. The luminance value Y is then processed by block 12 to obtain a processed color value having associated a processed luminance value Y′.

A graphical representation of the color value processing performed in block 10 of FIG. 3A is shown in FIG. 3B. As shown, an original color value (a) within an original space (e.g., RGB) is transformed to obtain an original luminance value Y. The original luminance value has an associated chrominance component and an associated luminance/chrominance based color space. Note that although the original color value (a) shows an associated chrominance value C in FIG. 3B, this chrominance value is not computed and is included within FIG. 3B to illustrate that the chrominance component (C) for the original color value (a) is the same as the chrominance component (C) for the processed color value (b). The original luminance value is then processed to obtain a processed color value (b) having an associated processed luminance value Y′ and having an associated chrominance component that is the same as the chrominance component of the original color value (a). According to the method shown in FIG. 3A, a processed color value R′,G′,B′ 15 is obtained by subtracting (via operator 13) the original luminance color value Y from the processed luminance color value Y′ to obtain a change in luminance value ΔY. The ΔY is then added (via operator 14) to each of the original R,G,B values to obtain a processed R′,G′,B′ color value. Note that only a single 3×1 forward transformation from the RGB color value to the original luminance value, Y, is required to obtain the processed color value 15 (R′,G′,B′).

One embodiment of the system and method of gamut clipping in accordance with the present invention is performed by block 16 in FIG. 3A and is described in terms of the graph illustrated in FIG. 3B. As shown in FIG. 3A, the processed color value R′,G′,B′ is provided to gamut clipping block 16. A target node or color value (Y₀) is selected by Select Target Node block 17 wherein a different target node can be selected for each color value in an image. The target node is located on the luminance axis within the original color space (RGB) as shown by point (c) in FIG. 3B and hence, the chrominance component of the target node is equal to zero. As can be seen in FIG. 3B, the target node is variable along the luminance axis within a valid luminance range. Hence, since the target node can vary from pixel to pixel in a given image when performing gamut clipping/mapping, the technique is referred to as variable node gamut clipping/mapping. By varying the target node for each pixel value in an image, gamut clipping/mapping is optimized for each pixel in the image.

FIG. 3A shows the original luminance value Y and the processed luminance value Y′ coupled to Select Target Node block 17. Also coupled to the block 17 is a Control Input 18 and Other Input 19. Control Input 18 allows for the selection of a different target node for each pixel value. Hence, the target node can be selected by setting the luminance component of the target node to one of the original luminance value Y or the processed luminance value Y′. By setting the target node to Y′ “straight chroma-clipping” is achieved since the luminance component of the mapped point (d) is the same as the luminance component of the pre-mapped point (b) while the chrominance component of the mapped point (d) is modified when compared to the chrominance component of the pre-mapped point (b). In addition, other values can be coupled to block 17 through input 18 so as to variably set the luminance value to values other than Y and Y′. For instance, the luminance value of the target node can be set to 0 or to a background luminance value. Control 18 can be provided by a user or from another source. The control can be provided either manually or automatically.

The selected target node value is coupled to Mapper block 20. Also coupled to Mapper block 20 is the process color value (R′,G′,B′) and ΔY. Mapper block 20 determines a mapped color value 26 by linearly projecting from the processed color value (b) to the selected target color value/node (c) (FIG. 3B). For the variable node clipping technique according to the present invention (shown in FIG. 3A) the processed color value is mapped to the boundary of the first color space (i.e., to point (d) and the mapped color value is located at the intersection of the first color space boundary and the projection of the line defined by points (b) and (c) as shown in FIG. 3B. In accordance with the system and method of variable node gamut clipping, the mapped color value is determined without performing any forward or backward chrominance channel transformations. Accordingly, only the 3×1 RGB to Y color value transformation is performed in accordance with system and method shown in FIG. 3A

In one embodiment, the original color space is an RGB color space as shown in FIG. 3A and the luminance/chrominance based color space corresponds to a YC₁C₂ type color space. It has been determined that the RGB and YC₁C₂ type color spaces have the following predetermined relationship as defined by Eqs. 4-6:

i) The forward transformation (T) from RGB to YC₁C₂ shown by Eq. 4a is linear:

$$[ \begin{matrix}Y \\ {C}_{1} \\ {C}_{2}\end{matrix} ] = T [ \begin{matrix}R \\ G \\ B\end{matrix} ] \qquad ( 4 a )$$

ii) The inverse transformation (T⁻¹) between YC₁C₂ and RGB exists (as shown in Eq. 4b);

$$[ \begin{matrix}R \\ G \\ B\end{matrix} ] = {T}^{- 1} [ \begin{matrix}Y \\ {C}_{1} \\ {C}_{2}\end{matrix} ] \qquad ( 4 b )$$

iii) The sum of the first row of T which determines Y is unity as shown by Eq. 5:

$${\sum }_{j = 1 : 3} {T}_{1 j} = 1 \qquad ( 5 )$$

iv) The sum of either the second row or the third row of T which determine C₁, C₂ is zero as shown by Eq. 6:

$${\sum }_{j = 1 : 3} {T}_{2 j} = {\sum }_{j = 1 : 3} {T}_{3 j} = 0 \qquad ( 6 )$$

In one embodiment, the determination of the mapped color value by linearly projecting from the processed color value (b) to the target color value (c) where the mapped color value is located on the original color space boundary is based on the mathematical expression shown in Eq. 7. This expression, in turn, is based on the above relationships shown in Eqs. 4-6 (for the cases when ΔY is less than or when ΔY greater than 0):

$$[ \begin{matrix}{R}^{″} \\ {G}^{″} \\ {B}^{″}\end{matrix} ] = {α}_{0} [ \begin{matrix}R + Δ Y \\ G + Δ Y \\ B + Δ Y\end{matrix} ] + ( 1 - {α}_{0} ) [ \begin{matrix}{Y}_{0} \\ {Y}_{0} \\ {Y}_{0}\end{matrix} ] \\ {α}_{0} = \{ \begin{matrix}( Δ Y > 0 ) & \frac{M - {Y}_{0}}{max \{ {R}^{′} , {G}^{′} , {B}^{′} \} - {Y}_{0}} \\ ( Δ Y < 0 ) & \frac{{Y}_{0}}{{Y}_{0} - ( min \{ {R}^{′} , {G}^{′} , {B}^{′} \} )}\end{matrix} \qquad ( 7 )$$

where M corresponds to the maximum color value range of each of the RGB channels (e.g., M=255 for an 8-bit representation) and where if α₀ is determined to be greater than 1 then α₀ is set to 1 such that no gamut clipping is performed. Equation 7 essentially corresponds to a mathematical representation for a given point (d) existing on the line projected from point (b) to (c) where the point (d) corresponds to the intersection of the gamut boundary and the line formed by points (b) and (c) (as shown in FIG. 3B). The implementation of this mathematical representation is shown in the Mapper block 20 in FIG. 3A. According to this technique, a minimum or maximum value of the three components of the processed color value (R′,G′,B′) are initially determined by block 21. This value is then provided to block 22 for determining the clipping factor α₀. The clipping factor is provided to block 23 for computation of the mathematical expression (1−α₀)Y₀. The multiply operator 24 multiplies each of the components of the processed color value R′,G′,B′ with the clipping factor α₀. The product of this operation is added using adder operator 25 to the resultant obtained from block 23 to generate the mapped color value 26. As will be noticed from the above expression, it does not require the chrominance component of the original color value and hence, no forward and backward chrominance transformation is required to gamut map/clip the processed color value. The form of the mathematical representation (Eq. 7) lends itself to a floating point implementation including divisional operations.

It should be understood that the processed color value can be mapped to the mapped color value based on mathematical expressions other than Eq. 7. For instance, Eq. 7 can be manipulated/re-arranged to obtain equivalent expressions that when implemented in a digital image processing systems results in an optimization of processing steps or system implementation to increase speed or efficiency of the mapping technique. For instance, Eq. 7 may be optimized so that only integer operations are performed by replacing the division operation (performed within block 22 to determine the clipping factor α₀) with a multiply and bit-shift operation while using a look-up table.

It should be understood that it is not beyond the scope of the invention to map value (b) back within the original color space (instead of to the boundary of the original color space). In particular, the variable node technique can be extended to a variable node mapping technique wherein the mapped value is determined by linearly projecting from the processed color value to the target node value and instead of the mapped color value being located on the intersection of the original color space and the projection, the color value is mapped along the projection somewhere within the color space.

The system and technique shown in FIG. 3A can optionally include Out-of-Gamut Pre-determination block 27 for determining whether the processed color value (b) will be out of gamut using the original color value 11 instead of the processed color value 15. This determination is made according to the following mathematical expressions:

out_of_gamut=(ΔY>0 AND max(R, G, B)>M−ΔY) OR (ΔY<0 AND min(R, G, B)<−ΔY) (8)

As can be seen the above expression determines whether the processed color value point is outside the RGB gamut only using the change in luminance value, thereby not requiring any chrominance component transformations and prior to processing of the original color value, (e.g., R,G,B). In reviewing the expression it can be seen that if ΔY>0, the RGB values can only increase and it is only necessary to test if the processed RGB values are not above the maximum allowed value M. Since all RGB values are shifted by the same amount ΔY, it is enough to test for max(R,G,B). A similar but opposite argument works for ΔY<0. Referring to FIG. 3A, block 27 receives the original color values 11 (e.g., R,G,B) and ΔY to make the out-of-gamut determination. If the out-of-gamut determination is false (i.e., neither of the above conditions in Eq. 8 apply), then a control signal is generated from block 27 thereby causing the R′,G′,B′ value to be passed through Mapper block 20 without modification. In this case, R″,G″,B″ is equal to R′,G′,B′. This may be achieved by disabling operation blocks 24 and 25. If the out-of-gamut determination is true (i.e., one of the above conditions in Eq. 8 apply), then Mapper block 20 functions to map/clip the R′,G′,B′ value to generate a modified value, R″,G″,B″.

Although it is shown in FIG. 3A that the maximum and minimum values of R′,G′,B′ are determined by block 21, this determination can be made by the Out-Of-Gamut Predetermination block 27 thereby eliminating the need for block 21. In particular, the maximum and minimum of the R,G,B values which is determined by block 27 (see Eq. 8) need only be added to ΔY to obtain the maximum and minimum of R′,G′,B′.

The advantage of this pre-test is that additional register operations of data can be avoided. For instance, if memory registers used to store the R,G,B values are limited to exactly an allowed range (e.g., 8-bit registers that cannot represent values outside the range 0-255), then potentially modified values R′,G′,B′ may exceed the register size and hence cannot be computed within the original R,G,B value registers. Consequently, in order to perform the out-of-gamut test on the processed color values (R′,G′,B′), three additional temporary registers having enough bits (e.g. 16-bit) to represent integers below 0 and above 255 (i.e., out of gamut color values). If gamut clipping is not needed, the modified R′,G′,B′ values then need to be converted back into an 8-bit representation for the remainder of the processing of the image data. If gamut-clipping is needed, the rest of computation must be carried out the larger sized representation, which is less hardware friendly than an 8-bit computation. In addition, the final result still has to be converted back to 8-bits. Hence, pre-testing whether the color values will be out-of-gamut on the original color values instead of the processed color values can optimize the gamut clipping process and system by ensuring that larger registers (with increased computation) are not required to perform the predetermination.

It should be noted that the technique of out-of-gamut pre-determination as described above can be performed in conjunction with other gamut mapping techniques other than shown in FIG. 3A and in which 1) only a luminance channel forward transformation is performed (i.e., no backward luminance channel transformation and no forward or backward chrominance channel transformations) on the original RGB color values and 2) where processing/enhancement is performed only on the transformed luminance channel. As described above significant advantages are gained by being able to make an out-of-gamut determination as efficient as possible. The efficiency is gained according to the present technique by using original RGB color values to make the determination in these types of gamut mapping systems. Hence, the present invention includes an out-of-gamut predetermination technique that is performed by determining the difference between the processed luminance value and the original luminance value (i.e., ΔY) and then making the out-of-gamut predetermination using only the original RGB color value (i.e., R,G,B), the gamut range M, and ΔY. In still another embodiment of this out-of-gamut predetermination technique, the predetermination is performed according to the expression shown by Eq. 8.

In the preceding description, numerous specific details are set forth in order to provide a thorough understanding of the present invention. It will be apparent, however, to one skilled in the art that these specific details need not be employed to practice the present invention. In addition, it is to be understood that the particular embodiments shown and described by way of illustration is in no way intended to be considered limiting. Reference to the details of these embodiments is not intended to limit the scope of the claims.

I claim:

1. A method of processing image data having a plurality of color values in an original color space, wherein an original color value of the plurality of color values is transformed to obtain an original luminance value, the original luminance value having an associated luminance/chrominance based color space and original chrominance values, and wherein the original luminance value is processed to obtain a processed color value having a processed luminance value and the original chrominance values, the method for mapping the processed color value into the original color gamut comprising:
selecting a target color value on a luminance axis, wherein a different target color value is selectable for each of a plurality of color values of the image data;
determining a mapped color value by linearly projecting from the processed color value towards the target color value, the mapped color value being located at the intersection of a gamut boundary of the original color space and the projection.

2. The method as described in claim 1 wherein the target color value has a corresponding luminance component and chrominance component equal to zero and wherein selecting the target color value is based on setting the luminance component to one of the group of the original luminance value, zero, the luminance component of the processed color value, and a background luminance value.

3. The method as described in claim 1 wherein the original color space is the RGB color space and the luminance/chrominance based color space is a YCC type color space wherein the transformation between the RGB and YCC color spaces is linear.

4. The method as described in claim 1 wherein the luminance/chrominance based color space has an associated luminance component and two chrominance components and wherein the original color space and the luminance/chrominance based color space have an associated invertible transformation relationship such that the sum of the weighting coefficients of the transform of the luminance component equals 1 and the sum of each of the weighting coefficients of the transform of each of the chrominance components equals 0.

5. The method as described in claim 1 wherein the selected target color value is selectable by one of a user and other control sources.

6. The method as described in claim 1 further comprising selecting by one of manual selection and automatic selection.

7. The method as described in claim 1 wherein determination of the mapped color value is based on the following mapping expression:
$$[ \begin{matrix}{R}^{″} \\ {G}^{″} \\ {B}^{″}\end{matrix} ] = {α}_{0} [ \begin{matrix}{R}^{′} \\ {G}^{′} \\ {B}^{′}\end{matrix} ] + ( 1 - {α}_{0} ) [ \begin{matrix}{Y}_{0} \\ {Y}_{0} \\ {Y}_{0}\end{matrix} ] \\ {α}_{0} = \{ \begin{matrix}( Δ Y > 0 ) & \frac{M - {Y}_{0}}{max \{ {R}^{′} , {G}^{′} , {B}^{′} \} - {Y}_{0}} \\ ( Δ Y < 0 ) & \frac{{Y}_{0}}{{Y}_{0} - ( min \{ {R}^{′} , {G}^{′} , {B}^{′} \} )}\end{matrix}$$
wherein ΔY is the difference between the original luminance value and the processed luminance value, M is the maximum allowable value of any color component of the RGB color space, Y₀ is the luminance component of the target color value, R,G,B is the original color value, R′,G′,B′ is the processed color value, and α₀ is a clipping value.

8. The method as described in claim 1 further comprising using the original color value to predetermine whether the original color value, once processed, will be out-of-gamut from the original color space.

9. The method as described in claim 8 wherein out-of-gamut pre-determining is performed according the following mathematical expression:
out_of_gamut=(ΔY>0 AND max(R, G, B)>M−ΔY) OR (ΔY<0 AND min(R, G, B)<−ΔY)

10. The method as described in claim 9 further comprising using the original color value to predetermine whether the original color value, once processed, will be out-of-gamut from the original color space, wherein out-of-gamut pre-determining is performed according the following mathematical expression:
out_of_gamut=(ΔY>0 AND max(R, G, B)>M−ΔY) OR (ΔY<0 AND min(R, G, B)<−ΔY)
and wherein max(R′,G′,B′) and min(R′,G′,B′) can be obtained from the determination of max(R,G,B), min(R,G,B).

11. A method of out-of-gamut predetermination in which an original RGB color value, having a corresponding gamut range M, is transformed to obtain an original luminance value, the original luminance value having associated original chrominance value, and wherein the original luminance value is processed to obtain a processed color value having a processed luminance value and the original chrominance values, the method comprising:
determining a difference between the processed luminance value and the original luminance value;
making the out-of-gamut predetermination using only the original RGB color value, the gamut range M, and the difference.

12. The method as described in claim 11 wherein making the out-of-gamut predetermination is performed according to the following mathematical expression:
out_of_gamut=(ΔY>0 AND max(R, G, B)>M−ΔY) OR (ΔY<0 AND min(R, G, B)<−ΔY)

13. A system of processing image data having a plurality of color values in an original color space, wherein an original color value of the plurality of color values is transformed to obtain an original luminance value, the original luminance value having an associated luminance/chrominance based color space and original chrominance values, and wherein the original luminance value is processed to obtain a processed color value having a processed luminance value and the original chrominance values, the system for mapping the processed color value into the original color gamut comprising:
a selector for selecting a target color value on a luminance axis, wherein a different target color value is selectable for each of the plurality of color values;
a color value mapper for determining a mapped color value by linearly projecting from the processed color value towards the target color value, the mapped color value being located at the intersection of a gamut boundary of the original color space and the projection.

14. The system as described in claim 13 wherein the target color value has a corresponding luminance component and a corresponding chrominance component equal to zero and the target color value is based on setting the luminance component to one of the group of the original luminance value, zero, the luminance component of the processed color value, and a background luminance value.

15. The system as described in claim 13 wherein the original color space is the RGB color space and the luminance/chrominance based color space is a YCC type color space wherein the transformation between the RGB and YCC color spaces is linear.

16. The system as described in claim 13 wherein the original color space is the RGB color space and the luminance based color space is a generalized based color space having an associated luminance color channel and two chrominance color channels.

17. The system as described in claim 13 wherein the luminance/chrominance based color space has an associated luminance component and two chrominance components and wherein the original color space and the luminance/chrominance based color space have an associated invertible transformation relationship such that the sum of the weighting coefficients of the transform of the luminance component equals 1 and the sum of each of the weighting coefficients of the transform of each of the chrominance components equals 0.

18. The system as described in claim 13 further including an input for allowing a user to select the target color value.

19. The system as described in claim 13 further including an input for one of automatic and manual selection.

20. The system as described in claim 13 wherein the color value mapper implements the following mathematical expression:
$$[ \begin{matrix}{R}^{″} \\ {G}^{″} \\ {B}^{″}\end{matrix} ] = {α}_{0} [ \begin{matrix}{R}^{′} \\ {G}^{′} \\ {B}^{′}\end{matrix} ] + ( 1 - {α}_{0} ) [ \begin{matrix}{Y}_{0} \\ {Y}_{0} \\ {Y}_{0}\end{matrix} ] \\ {α}_{0} = \{ \begin{matrix}( Δ Y > 0 ) & \frac{M - {Y}_{0}}{max \{ {R}^{′} , {G}^{′} , {B}^{′} \} - {Y}_{0}} \\ ( Δ Y < 0 ) & \frac{{Y}_{0}}{{Y}_{0} - ( min \{ {R}^{′} , {G}^{′} , {B}^{′} \} )}\end{matrix}$$
wherein ΔY is the difference between the original luminance value and the processed luminance value, M is the maximum allowable value of any color component of the RGB color space, Y₀ is the luminance component of the target color value, R,G,B is the original color value, R′,G′,B′ is the processed color value, and α₀ is a clipping value.

21. The method as described in claim 20 further comprising an out-of-gamut predeterminer for determining, using the original color value, whether the original color value, once processed, will be out-of-gamut from the original color space, wherein out-of-gamut pre-determining is performed according the following mathematical expression:
out_of_gamut=(ΔY>0 AND max(R, G, B)>M−ΔY) OR (ΔY<0 AND min(R, G, B)<−ΔY)
and wherein determination of max(R′,G′,B′), min(R′,G′,B′), max(R,G,B), and min(R,G,B are performed using, in part, the same processing steps by the predeterminer.

22. A method of processing image data having a plurality of color values in an original color space to obtain a mapped color value comprising:
transforming an original color value of the plurality of color values to obtain an original luminance value, the original luminance value having an associated luminance/chrominance based color space and original chrominance values;
processing the original luminance value to obtain a processed color value having a processed luminance value and the original chrominance values;
selecting a target color value on a luminance axis, wherein a different target color value is selectable for each of a plurality of color values of the image data;
determining a mapped color value by linearly projecting from the processed color value towards the target color value, the mapped color value being located at the intersection of a gamut boundary of the original color space and the projection.

23. A system of processing image data having a plurality of color values in an original color space to obtain a mapped color value comprising:
color value transformer for transforming an original color value of the plurality of color values to obtain an original luminance value, the original luminance value having an associated luminance/chrominance based color space and original chrominance values;
an image data processor processing the original luminance value to obtain a processed color value having a processed luminance value and the original chrominance values;
a selector for selecting a target color value on a luminance axis, wherein a different target color value is selectable for each of the plurality of color values;
a color value mapper for determining a mapped color value by linearly projecting from the processed color value towards the target color value, the mapped color value being located at the gamut intersection of a boundary of the original color space and the projection.

24. A computer readable medium for causing a processor in a computer system to perform processing instructions for mapping a processed color value into an original color gamut, the processed color value having an associated original color value of a plurality of color values of image data in the original color space comprising:
selecting a target color value on a luminance axis, wherein a different target color value is selectable for each of a plurality of color values of the image data;
determining a mapped color value by linearly projecting from the processed color value towards the target color value, the mapped color value being located at the intersection of a gamut boundary of the original color space and the projection.
